(19) United States
(12) Patent Application Publication
(10) Pub. No.: US 2024/0202779 A1
(43) Pub. Date: Jun. 20, 2024

(54) ADVERTISEMENT MANAGEMENT SYSTEM, ADVERTISEMENT MANAGEMENT METHOD, AND RECORDING MEDIUM

(71) Applicant: NEC Corporation, Tokyo (JP)

(72) Inventors: Kiri Inayoshi, Tokyo (JP); Kentaro Nishida, Tokyo (JP)

(73) Assignee: NEC Corporation, Tokyo (JP)

(21) Appl. No.: 18/543,014

(22) Filed: Dec. 18, 2023

(30) Foreign Application Priority Data
Dec. 20, 2022 (JP) 2022-202789

(51) Int. Cl. G06Q 30/0251; G06Q 30/0241

(52) U.S. Cl. CPC G06Q 30/0269; G06Q 30/0277

(57) ABSTRACT

An advertisement management system includes a detection unit, an analysis unit, a selection unit, and an output unit. The detection unit detects avatars associated with each other in a virtual space to which an advertisement is output. The analysis unit analyzes at least one of an action common to the avatars detected by the detection unit and a conversation content between the avatars. The selection unit selects an advertisement for a plurality of users participating in the virtual space by operating each avatar based on the analysis result. The output unit outputs an advertisement to be displayed in the virtual space based on the selection result.

This application is based upon and claims the benefit of priority from Japanese Patent Application No. 2022-202789, filed on Dec. 23, 2020, the disclosure of which is incorporated herein in its entirety by reference.

### TECHNICAL FIELD

The present disclosure relates to an advertisement management system and the like.

### BACKGROUND ART

An advertisement may be displayed in a virtual space. For example, an information processing system of PTL 1 (JP 2022-86072 A) estimates an attribute of a user who operates an avatar. Then, the information processing system of PTL 1 outputs an advertisement based on the estimated attribute.

### SUMMARY

An object of the present disclosure is to provide an advertisement management system or the like capable of outputting effective advertisements to a plurality of users who use a virtual space.

An advertisement management system according to one aspect of the present disclosure includes: a detection unit that detects avatars associated with each other in a virtual space to which an advertisement is output; an analysis unit that analyzes at least one of an action common to the avatars detected by the detection unit and a conversation content between the avatars; a selection unit that selects an advertisement for a plurality of users participating in the virtual space by operating each avatar based on an analysis result; and an output unit that outputs an advertisement to be displayed in the virtual space based on a result of the selection.

An advertisement management method according to an aspect of the present disclosure includes: detecting avatars associated with each other in a virtual space to which an advertisement is to be output; analyzing at least one of an action common to the detected avatars and a conversation content between the avatars; selecting an advertisement for a plurality of users participating in the virtual space by operating each avatar based on an analysis result; and outputting an advertisement to be displayed in the virtual space based on a result of the selection.

A non-transitory recording medium according to one aspect of the present disclosure records an advertisement management program that causes a computer to execute: detecting avatars associated with each other in a virtual space to which an advertisement is output; analyzing at least one of an action common to the detected avatars and a conversation content between the avatars; selecting an advertisement for a plurality of users participating in the virtual space by operating each avatar based on an analysis result; and outputting an advertisement to be displayed in the virtual space based on a result of the selection.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of a configuration of an example embodiment of the present disclosure;

FIG. 2 is a diagram illustrating an example of an advertisement management system according to the example embodiment of the present disclosure;

FIG. 3 is a diagram illustrating an example of a display screen according to the example embodiment of the present disclosure;

FIG. 4 is a diagram illustrating an example of a display screen according to the example embodiment of the present disclosure;

FIG. 5 is a diagram illustrating an example of a display screen according to the example embodiment of the present disclosure;

FIG. 6 is a diagram illustrating an example of a display screen according to the example embodiment of the present disclosure;

FIG. 7 is a diagram illustrating an example of an operation flow of the advertisement management system according to the example embodiment of the present disclosure; and

FIG. 8 is a diagram illustrating an example of a hardware configuration of the advertisement management system of the present disclosure.

### EXAMPLE EMBODIMENT

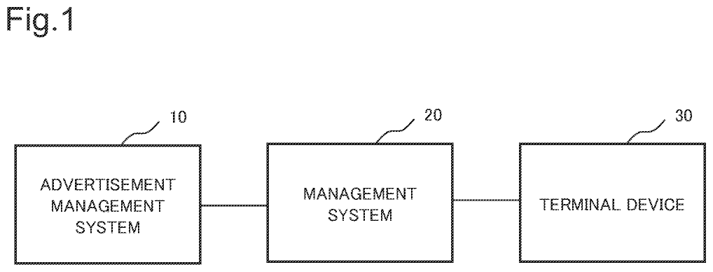

Example embodiments of the present disclosure will be described in detail with reference to the drawings. FIG. 1 is a diagram illustrating an outline of a configuration of a virtual space system of the present disclosure. The virtual space system includes, for example, an advertisement management system 10, a management system 20, and a terminal device 30. The advertisement management system 10 is connected to the management system 20 via a network. In addition, the management system 20 is connected to the terminal device 30 via a network. The numbers of management system 20 and terminal devices 30 can be appropriately set.

The virtual space system is, for example, a system in which a user who operates an avatar present in the virtual space performs an activity in the virtual space via the avatar. Here, the avatar refers to each avatar that the user using the virtual space operates to perform an activity in the virtual space. That is, even in the avatars of the same design, the respective avatars that perform activities in the virtual space by the operation of the user are regarded as different avatars from each other. Furthermore, the user may have a plurality of avatars. In a case where the user possesses a plurality of avatars, the user selects one of the plurality of avatars for each virtual space or according to a scene, and performs an activity in the virtual space by operating the selected avatar. In addition, a virtual space in which the user performs an activity via the avatar is also referred to as a metaverse space. The user interacts with another user via the avatar, for example. In the virtual space system of the present example embodiment, a common advertisement is presented to a plurality of users interacting with each other via an avatar. For example, when the user A and the user B are interacting with each other via the avatar, a common advertisement is output to the virtual space displayed on the terminal device 30 used by the user A and the terminal device 30 used by the user B. Furthermore, the advertisement to be output is a targeting advertisement for a plurality of users interacting with each other via the avatar. The advertisement to be output may be a tracking advertisement using the use history of the user. The tracking advertisement is an advertisement selected based on the use history of the user. The use history is, for example, a history of a visited virtual space, a history of a browsed advertisement, a history of an interaction with another user, and a history of a handled object. The use history may be a browsing history on the Internet, a browsing history on a social networking service (SNS), a posting history on the SNS, and a purchase history. The use history is not limited to the above.

For example, the advertisement management system 10 selects an advertisement to be output to the virtual space. Furthermore, the advertisement management system 10 manages, for example, the timing of outputting the advertisement to the virtual space. Furthermore, the management system 20 manages, for example, display of a space in the virtual space, display of an object in the space, and movement of an avatar in the space. Furthermore, the terminal device 30 is used, for example, for the user of the virtual space to operate the avatar in the space. For example, the advertisement management system 10 selects an advertisement to be output to the virtual space.

The interaction in the virtual space is performed, for example, by users talking with each other via the avatar. Furthermore, the interaction in the virtual space may be that the avatars perform actions associated with each other. The action of the avatar is an action performed by the avatar on the virtual space by the operation of the user. The action of the avatar is, for example, that the avatar operated by each user acts on the object. Furthermore, the action of the avatar may be that the avatar views the video displayed in the virtual space. The avatar viewing the video means that, for example, the face of the avatar is facing the direction in which the video is displayed. The action of the avatar may be participating in an event taking place in the virtual space. Furthermore, the action of the avatar may be participating in a game provided in the virtual space. The action of the avatar is not limited to the above.

The actions associated with each other means, for example, that the avatars operated by the respective users perform actions associated with each other. The actions associated with each other means, for example, that the avatars operated by the respective users act on the same object. The action on the object is, for example, to face the direction of the object. The action on the object may be that the avatar manipulates the object. The actions associated with each other may be that the avatars look at the same region in the virtual space. The actions associated with each other may be that the avatars view the same video. The actions associated with each other may be that the avatars participate in the same event or game. Furthermore, the actions associated with each other are not limited to the above. Furthermore, the interaction in the virtual space is not limited to the above.

The advertisement to be output to the virtual space is selected by the advertisement management system 10. The advertisement management system 10 is a system that manages advertisements output to the virtual space. For example, the advertisement management system 10 selects an advertisement to be output to the virtual space, determines a timing to output the advertisement, determines a timing to delete the advertisement, and determines a timing to switch contents of the advertisement.

The advertisement management system 10 selects a targeting advertisement for a group of users having a conversation with each other via avatars or a group of users whose avatars are performing actions associated with each other. The group of users is a group of users operating the avatars that have visited the virtual space and started a conversation or actions associated with each other. The users included in the group may be related to each other in the registration information. The users included in the group may not be related to each other in the registration information. The targeting advertisement is, for example, an advertisement in which a target person of the advertisement is likely to be interested in the content of the advertisement. That is, the advertisement management system 10 selects an advertisement having a content in which a plurality of users interacting with each other via the avatar is commonly interested. For example, the advertisement management system 10 selects an advertisement suitable for the target person of the advertisement based on the content of the conversation between the avatars or the action of the avatar. In addition, the advertisement management system 10 may select an advertisement suitable for a target person of the advertisement by further using the attribute of the user included in the group. Furthermore, the advertisement management system 10 may select an advertisement suitable for the target person of the advertisement by further using the attribute of the virtual space in which the avatar is active.

The virtual space is operated by, for example, an individual or a corporation. The virtual space operated by the corporation using the corporation name or the brand name may be operated as an official virtual space. The virtual space may incur a usage fee when the user uses the virtual space. Information related to the virtual space may be associated with the virtual space as a tag. The information related to the virtual space is, for example, information on one or more items of an operator, whether a usage fee is generated, a category to which the virtual space belongs, and whether the virtual space is official or unofficial. The information related to the virtual space is not limited to the above.

The attribute of the user is, for example, information related to the preference of the user who is an advertisement target. The information related to the preference of the user is, for example, information highly related to the tendency of interest of the user. The attribute of the user is, for example, information of one or more items of age, gender, occupation, family structure, residence, hometown, purchase history, and hobby. The attribute of the user may be a history of the virtual space in which the user has participated. The attribute of the user is not limited to the above.

The attribute of the virtual space is, for example, information related to setting and operation of the virtual space. The attribute of the virtual space is, for example, information on one or more items of information tagged to the virtual space, whether the virtual space is official or unofficial, whether the use of the virtual space is paid or free, category, tendency of skill of the user, target age, rank of the user, average of the number of friends of the user, the number of uses that can be connected at the same time, time period in which there are many visitors, design of the virtual space, installer, administrator, service to be provided, and elapsed days from the start. The attribute of the virtual space is not limited to the above.

The advertisement management system 10 selects an advertisement to be output to the virtual space based on at least one of the content of the conversation and the action. Then, the advertisement management system 10 outputs the selected advertisement to the management system 20, for example. For example, the management system 20 outputs the advertisement selected by the advertisement management system 10 to the terminal device 30 used by each user who is a target of the advertisement. The terminal device 30 outputs an advertisement to a display device, for example. The advertisement output to the terminal device 30 used by each target person of the advertisement is displayed on the display device, for example, so that each user who is a target of the advertisement visually recognizes the advertisement.

In this manner, by presenting the common targeting advertisement to the users interacting with each other via the avatar in the virtual space, for example, it is possible to increase the possibility that a conversation or a related action is performed on the content of the advertisement. The effect of the advertisement can be improved by increasing the possibility that the plurality of users included in the group have a conversation or a related action about the content of the advertisement.

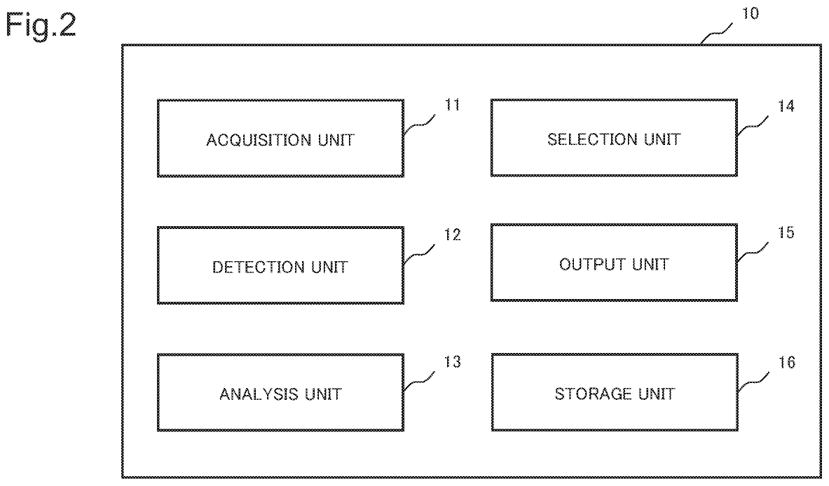

Here, an example of a specific configuration of the advertisement management system 10 will be described. FIG. 2 illustrates an example of a configuration of the advertisement management system 10 according to the present example embodiment. The advertisement management system 10 includes, as a basic configuration, a detection unit 12, an analysis unit 13, a selection unit 14, and an output unit 15. The advertisement management system 10 further includes, for example, an acquisition unit 11 and a storage unit 16.

For example, the acquisition unit 11 acquires data related to the avatar existing in the virtual space from the management system 20 of the virtual space. The acquisition unit 11 acquires, for example, data related to the identifier of the avatar, the attribute of the avatar, the position of the avatar in the virtual space, and the movement of the avatar. In a case where the virtual space is divided into a plurality of spaces, the acquisition unit 11 may acquire data related to an avatar present in a space to be a target for outputting an advertisement in the virtual space. The plurality of spaces are, for example, spaces that are operated according to the set design and theme of the space and the provided service. The avatar may be movable between a plurality of spaces. The plurality of spaces operated according to the set design and theme of the space and the provided service are also referred to as a world. The space operated according to the design, theme, and service to be provided of the set space may be divided into finer sections as a section in which a small number of avatars are active. Each of the sections obtained by further dividing the space operated according to the design and theme of the set space and the service to be provided is also referred to as a room. For example, in each world, for example, the design of the set space, the theme, and the provided service are different. The room is, for example, a space obtained by further dividing the world. The user interacts with other users by, for example, operating the avatar and visiting each room. Furthermore, a space having the same setting may be created for each group of registered users.

The acquisition unit 11 acquires, for example, data related to a conversation taking place between avatars. Furthermore, the acquisition unit 11 acquires data related to the action of the avatar existing in the virtual space. The data related to the action of the avatar is, for example, the direction in which the avatar is facing. The direction in which the avatar is facing is, for example, the direction in which the avatar's face is facing. The data related to the action of the avatar may be the direction of the line of sight of the avatar. The data related to the action of the avatar may be data indicating the action of the avatar on the object. The data indicating the action of the avatar on the object is, for example, data indicating either viewing the object or operating the object having the object. The data indicating the action of the avatar on the object is not limited to the above.

For example, the acquisition unit 11 acquires the attribute of the user who is operating the avatar existing in the virtual space. The user operating the avatar existing in the virtual space is, for example, a user participating in the virtual space via the avatar. Furthermore, the acquisition unit 11 acquires, for example, the attribute of the virtual space. The acquisition unit 11 may acquire advertisement data from another server connected via a network.

The detection unit 12 detects avatars associated with each other in a virtual space to which an advertisement is output. For example, the detection unit 12 detects avatars having a conversation with each other in the virtual space. Furthermore, the detection unit 12 detects, for example, avatars performing actions associated with each other in the virtual space.

For example, when the avatars are talking with each other in the room in the virtual space, the detection unit 12 detects the avatar participating in the conversation group. In a case where there is a plurality of groups having a conversation in the virtual space, the detection unit 12 detects the avatar for each group having a conversation, for example.

For example, when a plurality of avatars is performing an action on the same object in the virtual space, the detection unit 12 detects the avatar performing the action on the same object as avatars associated with each other. The action on the same object is, for example, that the avatar handles the same object. The action on the same object may be that the avatar is facing the direction of the same object. The actions of the plurality of avatars on the same object may be the same or different. For example, when the avatar A has an object and the avatar B is facing the same object, the avatar A and the avatar B are acting on the same object. Furthermore, in a case where a plurality of same or similar objects are arranged close to each other, even in a case where a plurality of avatars act on objects of different individuals, the plurality of avatars may act on the same object.

Furthermore, when a plurality of avatars faces the same region, the detection unit 12 may detect an avatar facing the same region as avatars associated with each other. Furthermore, the detection unit 12 may detect avatars that have moved at the same timing in the virtual space as avatars associated with each other. The movement in the virtual space is, for example, moving from the world or room in which the avatar is present to another world or room. In addition, the same timing includes within a set period. The movement at the same timing is, for example, movement between rooms during conversation.

The detection unit 12 may detect users related to the registration information among the users operating the avatar present in the virtual space as the users associated with each other. The users related to the registration information are, for example, users registered as friends with each other in the registration information of the user operating the avatar existing in the virtual space. The friend is, for example, information of a user who frequently interacts with each other. The user related to the registration information may include a user registered as a friend of the friend and a user belonging to the same group. The user related to the registration information is not limited to the above.

The detection unit 12 may detect, as users associated with each other, users whose interaction history satisfies the criteria among the users operating the avatar present in the virtual space. The reference of the interaction history is set using, for example, the number of times of conversation via the avatar in the past. For example, the detection unit 12 detects, among users operating the avatar in the virtual space, users who have had a conversation in the past a reference number of times or more as users associated with each other. The reference of the interaction history may be, for example, the number of times the operating avatar has been in the same virtual space in the past. The reference of the interaction history is not limited to the above.

The analysis unit 13 analyzes a target in which a plurality of users participating in the virtual space by operating the avatar are commonly interested based on the action of the avatar or the conversation content between the avatars. For example, the analysis unit 13 analyzes the content of the conversation taking place between the avatars based on the data related to the conversation acquired by the acquisition unit 11. The conversation being performed between the avatars is a conversation between users participating in the virtual space by operating the avatar. For example, the analysis unit 13 analyzes a conversation between avatars and extracts information related to selection of an advertisement. The analysis unit 13 extracts the field of conversation taking place between the avatars, for example, by analyzing the conversation taking place between the avatars. The field of conversation is, for example, information indicating which field the conversation made via the avatar relates to. When the conversation relates to travel, the field of conversation is, for example, travel. When the conversation relates to sports, the field of conversation is, for example, sports. The field of conversation may be hierarchical. In a case where the conversation relates to soccer among sports, the field of conversation may be soccer, for example. How to divide the field of conversation is not limited to the above. The analysis unit 13 may analyze the conversation between the avatars and extract a theme of the conversation taking place between the avatars. The theme of conversation is a more specific content of conversation in each field of conversation. When a conversation about where to travel is taking place between avatars, for example, the field of conversation is travel and the theme of the conversation is the destination of the travel.

For example, the analysis unit 13 analyzes the conversation between the avatars using an analysis model. In a case where the analysis unit 13 extracts a conversation field, the analysis unit 13 extracts a conversation field, for example, using an analysis model. Furthermore, in a case where the analysis unit 13 extracts a conversation theme, the analysis unit 13 extracts a conversation theme using, for example, an analysis model. The analysis model is generated, for example, by machine learning using a well-known natural language processing method.

The analysis unit 13 may detect the start and end of the conversation by analyzing the content of the conversation. The analysis unit 13 may detect the switching of the conversation content by analyzing the conversation content. For example, in a case where the field of conversation or the theme has changed, the analysis unit 13 detects that the content or the theme of the conversation has changed.

The analysis unit 13 may analyze a conversation state. The state of the conversation is, for example, excitement of the conversation. For example, the analysis unit 13 analyzes the degree of excitement of the conversation based on the frequency of remarks related to the same field. The analysis unit 13 may analyze the degree of excitement of the conversation based on the number of users who have made statements related to the same field or the ratio of users who have made statements. The analysis unit 13 may analyze the degree of excitement of the conversation based on the frequency of switching of the conversation field.

The analysis unit 13 may analyze the emotion of the user operating the avatar having a conversation. The analysis unit 13 uses, for example, an analysis model to analyze emotions of users having conversations. For example, the analysis model analyzes the emotion of the user having a conversation based on a phrase included in the conversation.

The analysis unit 13 analyzes, for example, the action of the avatar on the object. The analysis unit 13 analyzes, for example, a situation in which the avatar is operating the object. The analysis unit 13 analyzes, for example, at least one of the time, the number of times, and the frequency at which the avatar is operating the object. The avatar manipulating the object means, for example, that the avatar picks up the object and moves the object. The action of the avatar on the object may be that the avatar is looking at the object.

The analysis unit 13 may detect the start of the handling of the object and the end of the handling of the object by analyzing the action of the avatar on the object. For example, the analysis unit 13 analyzes whether the avatar handles an object depending on whether the avatar is operating an object. Furthermore, the analysis unit 13 may analyze whether the avatar is looking at the object based on the direction in which the avatar's face is facing.

The analysis unit 13 may analyze the reaction of the user to the advertisement. For example, the analysis unit 13 analyzes the reaction of the user to the advertisement by analyzing the conversation between the avatars or the action of the avatar while outputting the advertisement. For example, the analysis unit 13 analyzes the reaction to the advertisement by detecting a positive word and a negative word for the advertisement included in the conversation. For example, when a positive word is included for the advertisement included in the conversation, the analysis unit 13 determines that the user favorably reacts to the advertisement. Furthermore, for example, when a negative word is included for an advertisement included in the conversation, the analysis unit 13 determines that the user does not have a good feeling for the advertisement. The analysis unit 13 may analyze the conversation between the avatars, the action of the avatar, and the reaction of the user to the advertisement in real time based on the detection result from the detection unit 12.

The analysis unit 13 may analyze the effect of the advertisement. The effect of the advertisement is, for example, the degree of interest of the user who has viewed the advertisement in the advertisement. The effect of the advertisement may be that a user who sees the advertisement purchases a product related to the advertisement. In the case of analyzing the effect of the advertisement, the analysis unit 13 may calculate the billing amount to the advertiser based on the effect of the advertisement. For example, the analysis unit 13 analyzes the degree of interest of the user in the advertisement based on the action of the avatar operated by the user or the content of the conversation between the avatars. Then, the analysis unit 13 calculates the amount charged to the advertiser based on the degree of interest of the user in the advertisement. For example, the analysis unit 13 calculates the billing amount to the advertiser such that the higher the degree of interest of the user in the advertisement, the larger the amount of money. For example, the analysis unit 13 analyzes the degree of interest of the user in the advertisement based on the number of times the avatar looks at the advertisement or the time when the avatar looks at the advertisement. For example, the analysis unit 13 analyzes that the higher the number of times the avatar looks at the advertisement, the higher the degree of interest in the advertisement. Furthermore, for example, the analysis unit 13 analyzes that the longer the avatar looks at the advertisement, the higher the degree of interest in the advertisement.

In a case where the advertisement uses an object, the analysis unit 13 may analyze the effect of the advertisement based on the time or the number of times the avatar has handled the object. The analysis unit 13 may analyze the effect of the advertisement based on the number of avatars looking at the advertisement. In addition, when the advertisement is set as an entrance to another virtual space, the effect of the advertisement may be analyzed based on whether the advertisement passes through the entrance. Furthermore, in a case where the user who operates the avatar clicks a uniform resource locator (URL) displayed during the advertisement or in association with the advertisement to browse an external website, the analysis unit 13 may analyze the effect of the advertisement on the browsing of the external website. Furthermore, in a case where the advertisement leads to a purchasing activity inside and outside the virtual space, the analysis unit 13 may analyze an effect of the advertisement on the purchasing activity.

The analysis unit 13 may analyze the tendency of the action of the avatar. For example, the analysis unit 13 aggregates the number of times or the frequency of stay of the avatar for each position on the virtual space. Furthermore, the analysis unit 13 may generate a heat map indicating the tendency of the avatar's position in the virtual space based on the number of times or frequency of stays of the avatar. The heat map indicating the tendency of the presence position of the avatar can be used, for example, for setting the display position of the advertisement or setting the position where the avatar is arranged. The heat map indicating the tendency of the avatar's position may be presented to the advertiser as reference information for determining a position at which an advertisement is to be presented.

The selection unit 14 selects an advertisement for a plurality of users participating in the virtual space by operating each avatar based on the analysis result. For example, the selection unit 14 selects an advertisement to be output to the virtual space from among advertisements stored in the storage unit 16. Furthermore, the selection unit 14 may select an advertisement to be output to the virtual space from among advertisements stored in a storage means outside the advertisement management system 10. The selection of the advertisement includes selecting a guideline for determining the advertisement to be output to the virtual space. The guideline is, for example, information on what kind of advertisement is selected for the user operating the avatar. The guideline includes, for example, a field of advertisement to be selected, an industry type of an advertiser, an advertisement form, a length of the advertisement, and information of a user group targeted by the advertisement. The information included in the guideline is not limited to the above. For example, the selection unit 14 may select a guideline of an advertisement to be output to the virtual space. When the selection unit 14 selects a guideline of the advertisement to be output to the virtual space, for example, the management system 20 determines the advertisement to be output to the virtual space based on the selected guideline.

For example, the selection unit 14 selects an advertisement to be presented to a plurality of users participating in the virtual space via the avatar based on the content of the conversation. For example, the selection unit 14 selects a targeting advertisement to be commonly presented to a plurality of users based on the content of the conversation.

For example, the selection unit 14 selects an advertisement based on a conversation field. For example, the selection unit 14 selects an advertisement to be output to the virtual space from among advertisements having the same field as the field of conversation. For example, the selection unit 14 randomly selects an advertisement to be output to the virtual space from among advertisements having the same field. The same also includes being similar. The selection unit 14 may select an advertisement to be output to the virtual space from among advertisements of which themes match each other. For example, in a case where the field of conversation is travel, the selection unit 14 selects an advertisement to be output to the virtual space from among advertisements related to travel. Furthermore, in a case where the theme of conversation relates to a travel destination, the selection unit 14 selects an advertisement to be output to the virtual space from among advertisements for travel trips for respective areas.

The selection unit 14 may select an advertisement further based on at least one of the attribute of the user participating in the virtual space and the attribute of the virtual space. The selection unit 14 may select an advertisement based on both the attribute of the user participating in the virtual space and the attribute of the virtual space. For example, the selection unit 14 selects an advertisement to be output to the virtual space from among advertisements classified according to the attribute of the user participating in the virtual space and the content of the conversation. For example, the selection unit 14 randomly selects an advertisement to be output to the virtual space from among advertisements classified according to the attribute of the user participating in the virtual space and the content of the conversation. For example, the selection unit 14 may select the advertisement to be output to the virtual space based on a degree of matching between the attribute of the user participating in the virtual space and the attribute of the user set as the target of the advertisement. The degree of matching of the attributes is, for example, an index indicating whether the attribute of the user participating in the virtual space matches the attribute of the user set as the target of the advertisement. That is, the degree of matching of the attributes is an index indicating how much the attribute of the user participating in the virtual space matches the attribute of the user set as the target of the advertisement. For example, in a case where the attribute of the user set as the target of the advertisement is a woman who likes sports in her 20's, the degree of matching of the attributes with the user of the virtual space who is a 25-year-old woman who likes tennis becomes high.

For example, the selection unit 14 selects an advertisement having the highest degree of matching between the attribute of the user participating in the virtual space and the attribute of the user set as the target of the advertisement among the advertisements having the same conversation field, as the advertisement to be output to the virtual space. For example, in a case where a conversation is taking place on travel, the selection unit 14 selects an advertisement having the highest degree of matching of the attributes from among advertisements related to travel, as an advertisement to be output to the virtual space. The selection unit 14 may randomly select the advertisement to be output to the virtual space from among the advertisements having the same conversation field, the advertisements in which the degree of matching between the attribute of the user participating in the virtual space and the attribute of the user set as the target of the advertisement satisfies the criteria.

The selection unit 14 may select an advertisement by using a common attribute between users having a conversation or performing a related action. For example, in a case where a conversation about travel is taking place between users in their 60's, the selection unit 14 selects an advertisement related to a travel tour for users in their 60's. The selection unit 14 may select an advertisement using attributes of some users among users having a conversation or performing a related action. The selection unit 14 selects an advertisement based on, for example, attributes of a user who makes the most statements, a user who leads the statements, a user who has many friend registrants, an older person, or a younger person.

The selection unit 14 may select an advertisement to be output to the virtual space from among advertisements classified according to the attribute of the virtual space and the content of the conversation. For example, in a case where the virtual space reproduces a restaurant and a conversation is taking place about a dish, the selection unit 14 selects an advertisement to be output to the virtual space from among advertisements related to mail-order sale of dishes. For example, the selection unit 14 randomly selects an advertisement to be output to the virtual space from among advertisements classified according to the attribute of the virtual space and the content of the conversation. The selection unit 14 may select the advertisement to be output to the virtual space based on the degree of matching between the attribute of the virtual space and the attribute of the virtual space assumed as the output destination of the advertisement. The degree of matching of the attributes is, for example, an index indicating whether the attribute of the virtual space matches the attribute of the virtual space assumed as the output destination of the advertisement. That is, the degree of matching of the attributes is an index indicating how much the attribute of the virtual space matches the attribute of the virtual space assumed as the output destination of the advertisement. For example, the selection unit 14 selects, as the advertisement to be output to the virtual space, an advertisement having the highest degree of matching between the attribute of the virtual space that actually outputs the advertisement and the attribute of the virtual space assumed as the output destination of the advertisement, among the advertisements having the same conversation field. The selection unit 14 may randomly select an advertisement to be output to the virtual space from among advertisements of which the fields of conversation match each other, from among advertisements of which the degree of matching between the attribute of the virtual space in which the advertisement is actually output and the attribute of the virtual space assumed as the output destination of the advertisement satisfies the criteria.

The selection unit 14 may select an advertisement based on the action of the avatar. For example, the selection unit 14 selects an advertisement related to an object in which the user is interested based on the action of the avatar. For example, the selection unit 14 selects an advertisement based on an object handled by the avatar. For example, when the avatar is holding an object, the selection unit 14 selects an advertisement related to the holding object. For example, the selection unit 14 selects an advertisement related to a car when the avatar is holding an object of a model of the car. Furthermore, for example, when the avatar is looking at an object, the selection unit 14 selects an advertisement related to the object being looked at. For example, the selection unit 14 selects an advertisement related to a car when an avatar is looking at an object of a model of the car. Furthermore, the selection unit 14 may select an external website or a uniform resource locator (URL) of the external website as the advertisement.

In a case where a plurality of groups of avatars associated with each other exists in the virtual space, the selection unit 14 may select an advertisement for each of the groups. In a case where there is a plurality of groups having a conversation, the selection unit 14 selects an advertisement for each group based on the content of the conversation for each group, for example. In a case where there is a plurality of groups that are performing actions associated with each other, the selection unit 14 selects an advertisement for each group based on, for example, the action of each group.

The selection unit 14 may select an advertisement to be output to the virtual space using a selection model. The selection model is, for example, a machine-learned learning model that selects advertisements for a plurality of users based on attributes of the plurality of users and conversation contents. For example, the selection model estimates an advertisement suitable for a plurality of users using attributes and conversation contents of the plurality of users as inputs.

The selection model may be a learning model that selects an advertisement for a plurality of users based on attributes of the plurality of users and actions of the plurality of users. The selection model may be a learning model that selects an advertisement for a plurality of users based on attributes of the plurality of users, conversation contents, and actions of the plurality of users.

The selection model may be a learning model that selects an advertisement for a plurality of users based on the attribute of the virtual space and the conversation content. The selection model may be a learning model that selects an advertisement for a plurality of users based on the attribute of the virtual space and the action of the plurality of users. The selection model may be a learning model that selects an advertisement for a plurality of users based on the attribute of the virtual space, the conversation content, and the action of the plurality of users.

The selection model is generated, for example, by learning a relationship between attributes and conversation contents of a plurality of users and suitable advertisements. The selection model is generated by deep learning using a neural network, for example. The selection model may be generated by learning the relationship between the attributes of the plurality of users and the action of the avatar, and the suitable advertisement. The selection model may be generated by learning a relationship between attributes, conversation contents, and avatar action of a plurality of users and an advertisement suitable for the user.

The selection model is generated, for example, by learning the relationship between the attribute and the conversation content of the virtual space and the advertisement suitable for the user operating the avatar. The selection model may be generated by learning a relationship between the attribute of the virtual space and the action of the avatar, and the advertisement suitable for the user operating the avatar. The selection model may be generated by learning a relationship between the attribute of the virtual space, the conversation content, and the action of the avatar, and the advertisement suitable for the user operating the avatar. The selection model may be generated using another machine learning algorithm. The selection model may be generated by learning a relationship between the attributes of the plurality of persons, the attributes of the virtual space, the conversation content, and the action of the avatar and the advertisement suitable for the user operating the avatar. The selection model may be generated using another machine learning algorithm. The selection model is generated by, for example, a system outside the advertisement management system 10.

The selection unit 14 may select an advertisement based on restrictions on the content of the advertisement. For example, when selecting an advertisement using the use history of the user participating in the virtual space, the selection unit 14 does not use the use history that the user does not desire to use for the selection of the advertisement. In this case, the restriction on the content of the advertisement is that the use history of the user who participates in the virtual space by operating the avatar is not used for selection of the advertisement. For example, in a case where the user does not desire to use the use history related to the hobby, the selection unit 14 does not use the use history related to the hobby of the user who does not desire to use the use history.

The restriction on the content of the advertisement may be that an advertisement that the user of the virtual space does not desire to present is not selected. The restriction on the content of the advertisement is set, for example, as not selecting an advertisement that the user of the virtual space feels uncomfortable. The selection unit 14 selects an advertisement based on, for example, the user's restriction with the strictest restriction. The selection unit 14 may select an advertisement based on the restrictions of all the people participating in the virtual space that outputs the advertisement via the avatar.

The restriction on the content of the advertisement may be based on the criteria set by an operator of the virtual space. For example, the restriction on the content of the advertisement may be that an advertisement for which the operator of the virtual space determines that the content does not match the purpose of the room is not selected. The restriction related to the content of the advertisement is set based on, for example, the attribute of the virtual space and the field of the advertisement. For example, in a case where the virtual space is a space in which a theme park is reproduced, the restriction on the content of the advertisement is set such that that an advertisement related to business is not selected. Further, the restriction on the content of the advertisement may be selected from advertisements of areas set by the operator of the virtual space. For example, in a case where the virtual space is a space in which a theme park is reproduced, the restriction on the content of the advertisement is set by selecting an advertisement related to a product of a character appearing in the theme park.

The output unit 15 outputs an advertisement to be displayed in the virtual space based on a result of the selection by the selection unit 14. The output unit 15 outputs an advertisement to be displayed in the virtual space to the management system 20, for example. The output unit 15 outputs, for example, the advertisement data displayed in the virtual space and the identifier of the virtual space in which the advertisement is displayed in association with each other. The output unit 15 may output the advertisement data displayed in the virtual space in association with the identifier of the user or the avatar that is the target of the advertisement. For example, the output unit 15 may output an advertisement to be displayed in the virtual space to the terminal device 30 used by the user of the advertisement target. In addition, when the selection unit 14 selects a guideline of an advertisement to be displayed in the virtual space, the output unit 15 may output the guideline of the advertisement to the management system 20, for example.

In a case where the advertisement is displayed as an object, the output unit 15 outputs, for example, data of the object displayed as the advertisement in the virtual space. The output unit 15 outputs, for example, data of an object to be displayed as an advertisement in the virtual space to the management system 20. The output unit 15 outputs, for example, data of an object to be displayed as an advertisement in the virtual space to the terminal device 30 used by the user of the advertisement target.

The output unit 15 may control the timing related to the output of the advertisement based on the action of the avatar or the conversation content between the avatars. The output unit 15 displays the advertisement, deletes the advertisement, and switches the content of the advertisement according to the content of the conversation analyzed by the analysis unit 13, for example. The output unit 15 may delete the advertisement and switch the content of the advertisement at a timing when the conversation shifts to another topic according to the emotion of the user of the virtual space. Furthermore, the output unit 15 may delete the advertisement and switch the content of the advertisement at a timing when a certain period of time has elapsed since the conversation shifted to another topic.

The output unit 15 may control the timing related to the output of the advertisement based on the reaction of the user participating in the virtual space to the advertisement displayed in the virtual space based on the analysis result from the analysis unit 13. The output unit 15 deletes the advertisement and switches the content of the advertisement based on, for example, negative statements on the advertisement, the number of people watching the advertisement, the time when the avatar is watching the advertisement, and the emotion of the person watching the advertisement.

The output unit 15 may output the advertisement when a plurality of avatars face the display area of the advertisement. Furthermore, the output unit 15 may output an object used as an advertisement in a case where a plurality of avatars face a display place of the object. The direction the avatar is facing is determined, for example, based on the direction of the line of sight, face, or head of the avatar.

In a case where the video is displayed in the virtual space, the output unit 15 may output the advertisement selected by the selection unit 14 at a timing when the display of the video ends. Furthermore, the output unit 15 may output the advertisement selected by the selection unit 14 at a timing when the display of the video in the display area of the advertisement ends. Furthermore, the output unit 15 may output the advertisement selected by the selection unit 14 at the timing when the game using the object ends. In addition, the output unit 15 may output the advertisement selected by the selection unit 14 at a timing when the played music ends. In addition, the output unit 15 may output the advertisement selected by the selection unit 14 at a timing when the presentation performed on the virtual space ends. The production performed in the virtual space is, for example, reproduction of an event performed in the real world by a video. The timing of outputting the advertisement is not limited to the above.

The output unit 15 may delete the advertisement and switch the content of the advertisement when the avatar enters a new virtual space. The output unit 15 may delete the advertisement and switch the content of the advertisement when the avatar looks at the specified object. The output unit 15 may delete the advertisement and switch the content of the advertisement when the avatar approaches the designated object. The output unit 15 may delete the advertisement and switch the content of the advertisement when the avatar moves away from the advertisement. Alternatively, the output unit 15 may delete the advertisement and switch the content of the advertisement when the avatar looks at a place different from the advertisement.

In a case where the analysis unit 13 analyzes the tendency of the action of the avatar, the output unit 15 may further output a result of analyzing the tendency of the action of the avatar to the management system 20. The result of analyzing the tendency of the action of the avatar is used, for example, for setting a display area of an advertisement, setting content of the advertisement, and setting a guideline for selecting the advertisement. The output unit 15 may output a result of analyzing the tendency of the action of the avatar to a terminal device used by the administrator of the virtual space. Furthermore, in a case where the analysis unit 13 has generated the heat map for each position on the virtual space based on the number of times or frequency of stay of the avatar, the output unit 15 outputs the generated heat map to the management system 20, for example. The output unit 15 may output the generated heat map to a terminal device used by an administrator of the virtual space.

In a case where there is a plurality of avatar groups that perform a conversation or a related action in the virtual space, the output unit 15 outputs an advertisement to each group, for example. The output unit 15 outputs different advertisements to a plurality of groups as advertisements for a single advertisement display space on the virtual space, for example. In a case where there are the group A and the group B, for example, the output unit 15 outputs an advertisement according to each group to a virtual space visible to the user who operates the avatar belonging to the group A and a virtual space visible to the user who operates the avatar belonging to the group B. The advertisement for the group A and the advertisement for the group B are displayed, for example, in an advertisement display space on the virtual space. That is, for example, the user of the group A and the user of the group B look as if advertisements having different contents are displayed in the advertisement display space at the same position on the virtual space. Furthermore, in a case where an object is used as an advertisement, when an avatar of any group handles the object, the output unit 15 may output the object so that all users who operate the avatar existing in the virtual space can visually recognize the same object. For example, when the group A and the group B exist, and the avatar of the group A handles an object displayed as an advertisement, the output unit 15 may output the avatar handled in the group A to a virtual space visible to the user of the group B.

The storage unit 16 stores, for example, data related to selection of an advertisement. The storage unit 16 stores, for example, criteria for selecting an advertisement. The storage unit 16 stores, for example, restrictions used for selection of an advertisement. In a case where the action of the avatar or the conversation between the avatars is analyzed using the analysis model, the storage unit 16 stores the analysis model, for example. The analysis model may be stored in a storage means outside the advertisement management system 10. When an advertisement is selected using the selection model, the storage unit 16 stores, for example, the selection model. The selection model may be stored in a storage means outside the advertisement management system 10. In a case where the timing of outputting the advertisement is controlled, the storage unit 16 stores a reference of the timing of outputting the advertisement. Furthermore, the storage unit 16 may store data of the advertisement displayed in the virtual space.

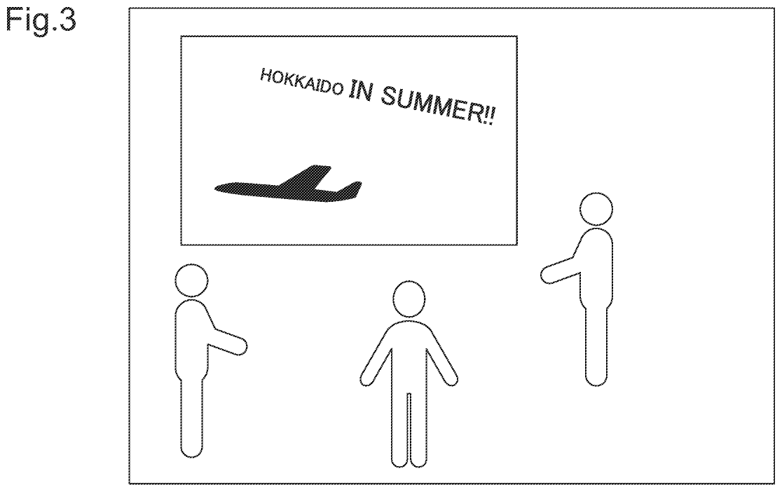

FIG. 3 is a diagram illustrating an example of a display screen of the virtual space and an advertisement displayed on the display screen of the virtual space. In the example of the display screen of FIG. 3, an advertisement with a picture of an airplane is displayed together with characters “Hokkaido in summer” in the display field of the advertisement. Furthermore, in the example of the display screen of FIG. 3, three avatars are looking in the direction of the advertisement. The advertisement in the example of the display screen of FIG. 3 is displayed, for example, in a case where a plurality of avatars are talking about a travel destination.

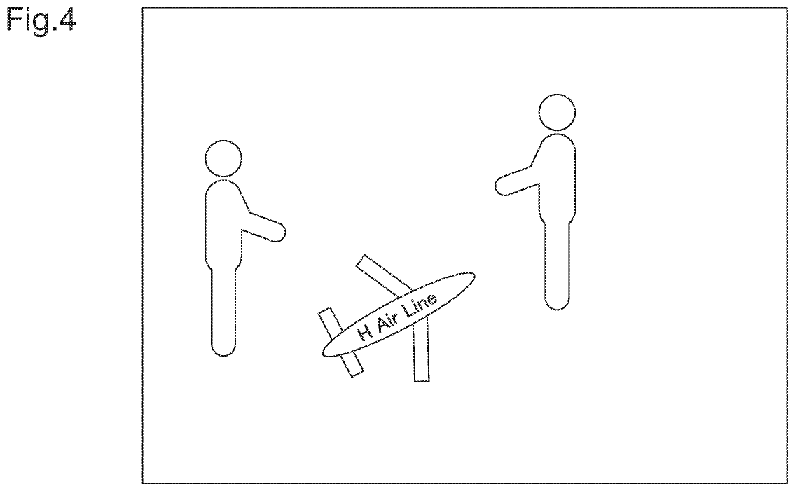

FIG. 4 is a diagram illustrating an example of a display screen of the virtual space and an advertisement displayed as an object on the display screen of the virtual space. In the example of the display screen of FIG. 4, the company name “H Air Line” is displayed on the airplane object. The advertisement in the example of the display screen of FIG. 4 is displayed, for example, when a plurality of avatars are talking about transportation means of travel.

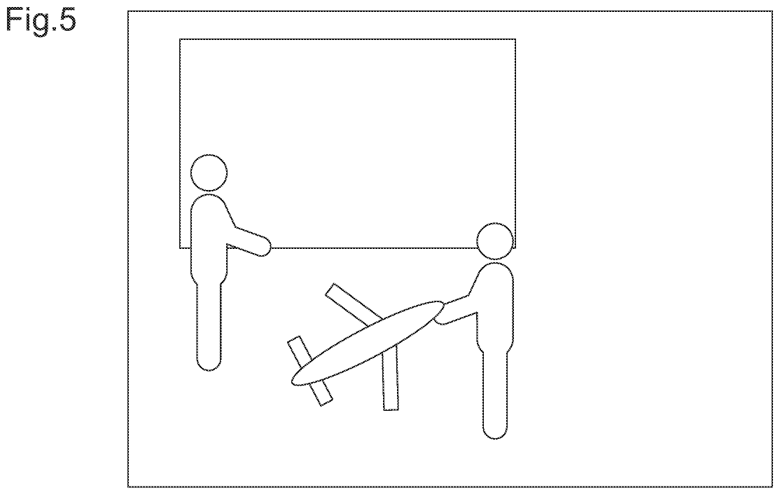

FIG. 5 is an example of a display screen of a virtual space, an object, and an avatar display screen. In the example of the display screen of FIG. 5, one avatar of the two avatars holds an airplane object.

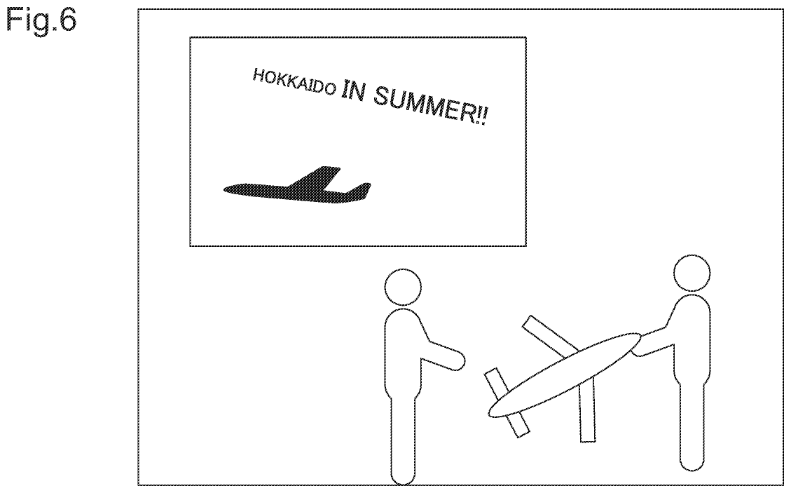

FIG. 6 is a diagram illustrating an example in which an advertisement related to an object in which the avatar is interested is displayed on the display screen of the virtual space. In the example of the display screen of FIG. 6, one avatar holds an airplane object. In the example of the display screen of FIG. 6, an advertisement on which a picture of an airplane related to an object held by the avatar is drawn is displayed.

For example, the management system 20 controls the action of the avatar in the virtual space such that the avatar acts in accordance with the operation of the user. The management system 20 controls, for example, a conversation between avatars. For example, the management system 20 acquires an input related to the operation of the avatar by the user from the terminal device 30. The management system 20 controls the action of the avatar based on, for example, an input related to the operation of the avatar by the user.

The management system 20 controls the display of the virtual space and the display of the avatar operating on the virtual space. The management system 20 outputs, for example, the display of the virtual space and the display data of the avatar operating on the virtual space to the terminal device 30. The management system 20 controls display of an advertisement in the virtual space. For example, the management system 20 outputs the selected advertisement from the advertisement management system 10. Then, the management system 20 outputs the advertisement data selected by the advertisement management system 10 to the terminal device 30 operated by the advertisement target user, for example. The management system 20 controls a timing at which an advertisement is displayed based on information indicating an output timing of the advertisement transmitted from the advertisement management system 10.

The terminal device 30 is, for example, a terminal device in which the user of the virtual space operates the avatar and browses the virtual space. The terminal device 30 acquires, for example, an input related to the operation of the avatar input by the operation of the user. The terminal device 30 outputs, for example, an input related to the operation of the avatar to the management system 20. Furthermore, the terminal device 30 acquires the virtual space and the display data of the avatar from the management system 20, for example. Furthermore, the terminal device 30 acquires, for example, advertisement data to be displayed in the virtual space from the management system 20. The terminal device 30 outputs a display screen related to the virtual space to a display device (not illustrated), for example. The display screen related to the virtual space includes, for example, a design, an avatar, an object, and an advertisement of the virtual space.

As the terminal device 30, for example, a smartphone, a personal computer, a tablet computer, or a wearable terminal can be used. Furthermore, the terminal device 30 may include a head-mounted display. The terminal device 30 is not limited to the above.

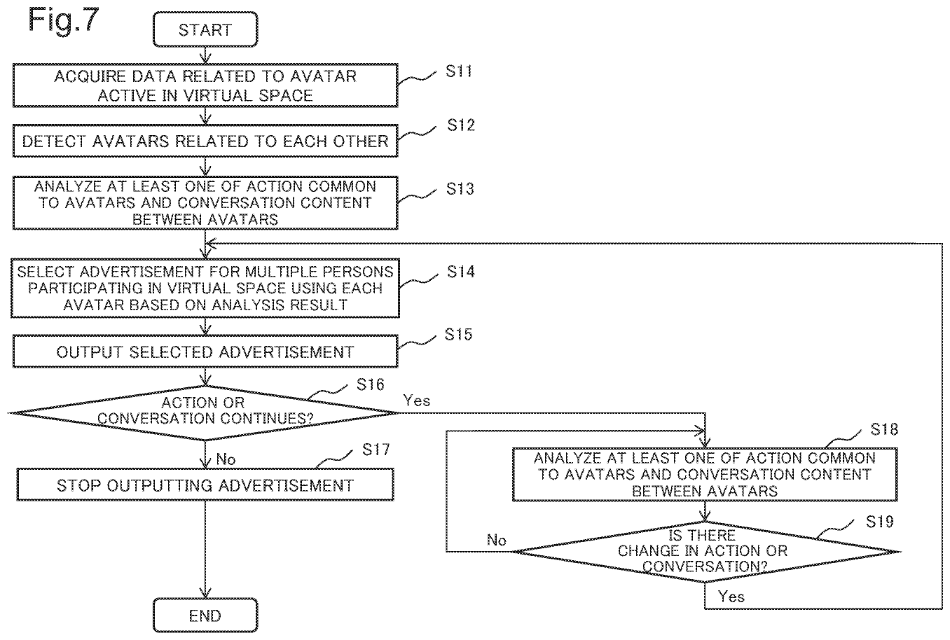

An operation of the advertisement management system 10 will be described. FIG. 7 is a diagram illustrating an example of an operation flow of the advertisement management system 10.

The acquisition unit 11 acquires, for example, data related to the avatar active in the virtual space (step S11). The acquisition unit 11 acquires, for example, data related to the avatar active in the virtual space from the management system 20 that controls the virtual space.

When the data related to the avatar is acquired, the detection unit 12 detects the avatars associated with each other in the virtual space to which the advertisement is output (step S12).

When the avatars associated with each other are detected, the analysis unit 13 analyzes at least one of the action common to the avatars detected by the detection unit 12 and the conversation content between the avatars (step S13).

When the action or conversation of the avatar is analyzed, the selection unit 14 selects an advertisement for a plurality of users participating in the virtual space using each avatar based on the analysis result (step S14).

When the content of the advertisement is selected, the output unit 15 outputs the advertisement based on the selected content to the virtual space (step S15). The output unit 15 outputs an advertisement to the management system 20 that controls the virtual space, for example. When the content of the advertisement is acquired, the management system 20 outputs the advertisement to, for example, the terminal device 30 used by the target user of the advertisement. When acquiring the advertisement, the terminal device 30 outputs the advertisement to the display device, for example. The user visually recognizes the advertisement displayed on the display device.

After outputting the advertisement, in a case where the action or the conversation continues (Yes in step S16), the analysis unit 13 analyzes at least one of the action common to the avatars and the conversation content between the avatars (step S18).

In a case where there is a change in the action or the conversation (Yes in step S19), the processing returns to step S14, and the selection unit 14 selects an advertisement for a plurality of users participating in the virtual space using each avatar based on the analysis result (step S14).

In step S19, in a case where there is no change in the action or the conversation (No in step S19), the processing returns to step S18, and the analysis unit 13 analyzes at least one of the action common to the avatar and the conversation content between the avatars (step S18).

After outputting the advertisement, in a case where the action or the conversation is not continued (No in step S16), the output unit 15 stops outputting the advertisement (step S17). For example, the output unit 15 stops outputting the advertisement at a set timing.

The advertisement management system 10 according to the present example embodiment detects avatars associated with each other in a virtual space to which an advertisement is output. Furthermore, the advertisement management system 10 analyzes at least one of the detected action common to the avatars and the conversation content between the avatars. Then, the advertisement management system 10 selects an advertisement for a plurality of users participating in the virtual space using each avatar based on the analysis result. As described above, by selecting an advertisement based on at least one of an action common to a plurality of avatars active in the virtual space and a conversation content between the avatars, it is possible to select an advertisement suitable for a plurality of users. Therefore, by using the advertisement management system 10, it is possible to output effective advertisements to a plurality of users in the virtual space.

In a case where an advertisement is selected by using a restriction not to display an advertisement having a content that the user does not desire to display, for example, display of an advertisement that is not suitable for the user can be avoided, and thus the effect of the advertisement can be further enhanced. Furthermore, for example, in a case where the timing of outputting the advertisement is controlled based on the content of the conversation or the situation of the conversation, for example, the possibility of having a conversation related to the advertisement can be increased. Therefore, it is possible to further enhance the effect of advertising for a plurality of users. Furthermore, in a case where the timing of outputting the advertisement is controlled based on the direction in which the avatar is facing, for example, by not switching the advertisement when the user is facing the advertisement, it is possible to present the advertisement to the user without making the user aware that the user is a target of the targeting advertisement.

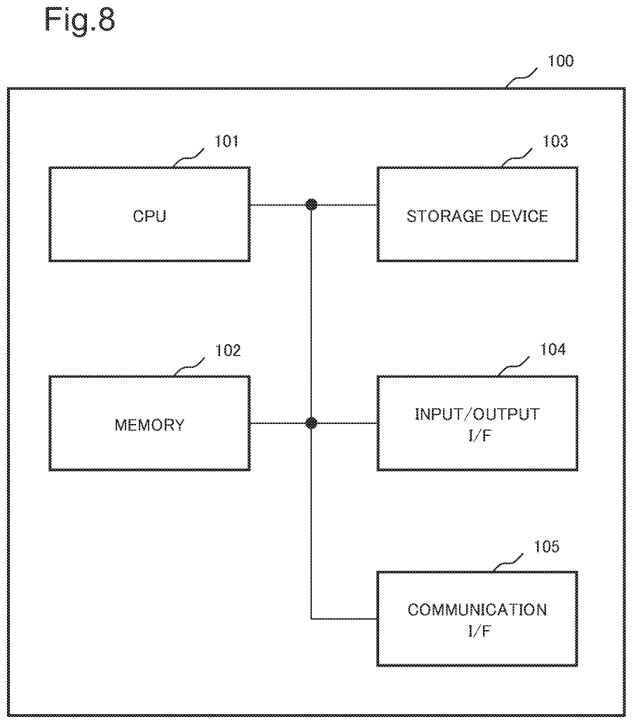

Each processing in the advertisement management system 10 can be achieved by executing a computer program by a computer. FIG. 8 illustrates an example of a configuration of a computer 100 that executes a computer program for performing each processing in the advertisement management system 10. The computer 100 includes, for example, a central processing unit (CPU) 101, a memory 102, a storage device 103, an input/output interface (I/F) 104, and a communication I/F 105.

The CPU 101 reads and executes a computer program for performing each processing from the storage device 103. The CPU 101 may be configured by a combination of a plurality of CPUs. In addition, the CPU 101 may be configured by a combination of a CPU and another type of processor. For example, the CPU 101 may be configured by a combination of a CPU and a graphics processing unit (GPU). The memory 102 includes a dynamic random access memory (DRAM) or the like, and temporarily stores a computer program executed by the CPU 101 and data being processed. The storage device 103 stores a computer program executed by the CPU 101. The storage device 103 includes, for example, a nonvolatile semiconductor storage device. As the storage device 103, another storage device such as a hard disk drive may be used. The input/output I/F 104 is an interface that receives an input from an operator and outputs display data and the like. The communication I/F 105 is an interface that transmits and receives data to and from another information processing apparatus.

The computer program used for executing each processing can also be allocated by being stored in a computer-readable recording medium that non-transitorily records data. As the recording medium, for example, a magnetic tape for data recording or a magnetic disk such as a hard disk can be used. As the recording medium, an optical disk such as a compact disc read only memory (CD-ROM) can also be used. A nonvolatile semiconductor storage device may be used as a recording medium.

An interaction using a virtual space is performed in various fields. The user of the virtual space interacts with other users via an avatar. The virtual space in which the user participates by operating the avatar present in the virtual space is also referred to as a metaverse space. Furthermore, in the virtual space, for example, an advertisement may be displayed for monetization. In the virtual space, for example, a common advertisement is displayed for a plurality of users in the space. For this reason, in a case where an advertisement is displayed in the virtual space, a plurality of users who operate avatars existing in the same space may browse the same advertisement. Furthermore, the display of the advertisement may be performed by displaying content corresponding to the user participating in the virtual space as the targeting advertisement. In the targeting advertisement, for example, an advertisement considered to have a high advertising effect is displayed to the user of the virtual space.

The related art described in the background art causes a problem, such as it is difficult to output an advertisement that is interest by a plurality of users of a virtual space. An example advantage according to the present disclosure is that effective advertisements can be output to a plurality of users who use a virtual space.

Some or all of the above embodiments may be described as the following supplementary notes, but are not limited to the following.

### [Supplementary Note 1]

An advertisement management system including:
at least one memory storing instructions; and
at least one processor configured to access the at least one memory and execute the instructions to:
detect avatars associated with each other in a virtual space to which an advertisement is output;
analyze at least one of an action common to the avatars detected by the detection unit and a conversation content between the avatars;
select an advertisement for a plurality of users participating in the virtual space by operating each avatar based on an analysis result; and
output an advertisement to be displayed in the virtual space based on a result of the selection.

### [Supplementary Note 2]

The advertisement management system according to Supplementary Note 1, wherein
the at least one processor is further configured to execute the instructions to:
select the advertisement further based on at least one of an attribute of a user participating in the virtual space and an attribute of the virtual space.

### [Supplementary Note 3]

The advertisement management system according to Supplementary Note 1, wherein
the at least one processor is further configured to execute the instructions to:
analyze a target in which a plurality of users participating in the virtual space by operating the avatar are interested in common based on an action of the avatar or a conversation content between the avatars.

### [Supplementary Note 4]

The advertisement management system according to Supplementary Note 1, wherein the at least one processor is further configured to execute the instructions to:
exclude use a use history not desired to be used by the user from selection of the advertisement when the advertisement is selected using the use history of the user who participates in the virtual space by operating the avatar.

### [Supplementary Note 5]

The advertisement management system according to Supplementary Note 1, wherein
the at least one processor is further configured to execute the instructions to:
control a timing related to output of the advertisement based on an action of the avatar or a conversation content between the avatars.

### [Supplementary Note 6]

The advertisement management system according to Supplementary Note 6, wherein
the at least one processor is further configured to execute the instructions to:
control the timing related to the output of the advertisement based on a reaction of the user participating in the virtual space by operating each of the plurality of avatars with respect to the output advertisement.

### [Supplementary Note 7]

The advertisement management system according to Supplementary Note 5, wherein
the at least one processor is further configured to execute the instructions to:
control the timing related to the output of the advertisement based on directions of lines of sight, faces, or heads of the plurality of avatars.

### [Supplementary Note 8]

The advertisement management system according to Supplementary Note 1, wherein
the at least one processor is further configured to execute the instructions to:
select an advertisement for each of a plurality of groups of avatars associated with each other in the virtual space.

### [Supplementary Note 9]

An advertisement management method including:
detecting avatars associated with each other in a virtual space to which an advertisement is to be output;
analyzing at least one of an action common to the detected avatars and a conversation content between the avatars;
selecting an advertisement for a plurality of users participating in the virtual space by operating each avatar based on an analysis result; and
outputting an advertisement to be displayed in the virtual space based on a result of the selection.

### [Supplementary Note 10]

The advertisement management method according to Supplementary Note 9, further including:
selecting the advertisement further based on at least one of an attribute of a user participating in the virtual space and an attribute of the virtual space.

### [Supplementary Note 11]

The advertisement management method according to Supplementary Note 9, further including:
analyzing a target in which a plurality of users participating in the virtual space by operating the avatar are interested in common based on an action of the avatar or a conversation content between the avatars.

### [Supplementary Note 12]

The advertisement management method according to Supplementary Note 9, further including:
excluding use a use history not desired to be used by the user from selection of the advertisement when the advertisement is selected using the use history of the user who participates in the virtual space by operating the avatar.

### [Supplementary Note 13]

The advertisement management method according to Supplementary Note 9, further including:
controlling a timing related to output of the advertisement based on an action of the avatar or a conversation content between the avatars.

### [Supplementary Note 14]

The advertisement management method according to Supplementary Note 13, further including:
controlling the timing related to the output of the advertisement based on a reaction of the user participating in the virtual space by operating each of the plurality of avatars with respect to the output advertisement.

### [Supplementary Note 15]

The advertisement management method according to Supplementary Note 13, further including:
controlling the timing related to the output of the advertisement based on directions of lines of sight, faces, or heads of the plurality of avatars.

### [Supplementary Note 16]

The advertisement management method according to Supplementary Note 9, further including:
selecting an advertisement for each of a plurality of groups of avatars associated with each other in the virtual space.

### [Supplementary Note 17]

A non-transitory recording medium recording an advertisement management program for causing a computer to execute:
detecting avatars associated with each other in a virtual space to which an advertisement is output;
analyzing at least one of an action common to the detected avatars and a conversation content between the avatars;
selecting an advertisement for a plurality of users participating in the virtual space by operating each avatar based on an analysis result; and
outputting an advertisement to be displayed in the virtual space based on a result of the selection.

### [Supplementary Note 18]

The non-transitory recording medium recording the advertisement management program according to Supplementary Note 17, wherein
the advertisement management program further causes the computer to execute:
selecting the advertisement further based on at least one of an attribute of a user participating in the virtual space and an attribute of the virtual space.

### [Supplementary Note 19]

The non-transitory recording medium recording the advertisement management program according to Supplementary Note 17, wherein
the advertisement management program further causes the computer to execute:
analyzing a target in which a plurality of users participating in the virtual space by operating the avatar are interested in common based on an action of the avatar or a conversation content between the avatars.

### [Supplementary Note 20]

The non-transitory recording medium recording the advertisement management program according to Supplementary Note 17, wherein
the advertisement management program further causes the computer to execute:
excluding use a use history not desired to be used by the user from selection of the advertisement when the advertisement is selected using the use history of the user who participates in the virtual space by operating the avatar.

### [Supplementary Note 21]

The non-transitory recording medium recording the advertisement management program according to Supplementary Note 17, wherein
the advertisement management program further causes the computer to execute:
controlling a timing related to output of the advertisement based on an action of the avatar or a conversation content between the avatars.

### [Supplementary Note 22]

The non-transitory recording medium recording the advertisement management program according to Supplementary Note 21, wherein
the advertisement management program further causes the computer to execute:
controlling the timing related to the output of the advertisement based on a reaction of the user participating in the virtual space by operating each of the plurality of avatars with respect to the output advertisement.

### [Supplementary Note 23]

The non-transitory recording medium recording the advertisement management program according to Supplementary Note 21, wherein
the advertisement management program further causes the computer to execute:
controlling the timing related to the output of the advertisement based on directions of lines of sight, faces, or heads of the plurality of avatars.

### [Supplementary Note 24]

The non-transitory recording medium recording the advertisement management program according to Supplementary Note 17, wherein
the advertisement management program further causes the computer to execute:
selecting an advertisement for each of a plurality of groups of avatars associated with each other in the virtual space.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An advertisement management system comprising:
at least one memory storing instructions; and
at least one processor configured to access the at least one memory and execute the instructions to:
detect avatars associated with each other in a virtual space to which an advertisement is output;
analyze at least one of an action common to the avatars detected by the detection unit and a conversation content between the avatars;
select an advertisement for a plurality of users participating in the virtual space by operating each avatar based on an analysis result; and
output an advertisement to be displayed in the virtual space based on a result of the selection.

2. The advertisement management system according to claim 1, wherein
the at least one processor is further configured to execute the instructions to:
select the advertisement further based on at least one of an attribute of a user participating in the virtual space and an attribute of the virtual space.

3. The advertisement management system according to claim 1, wherein
the at least one processor is further configured to execute the instructions to:
analyze a target in which a plurality of users participating in the virtual space by operating the avatar are interested in common based on an action of the avatar or a conversation content between the avatars.

4. The advertisement management system according to claim 1, wherein
the at least one processor is further configured to execute the instructions to:
exclude use a use history not desired to be used by the user from selection of the advertisement when the advertisement is selected using the use history of the user who participates in the virtual space by operating the avatar.

5. The advertisement management system according to claim 1, wherein
the at least one processor is further configured to execute the instructions to:
control a timing related to output of the advertisement based on an action of the avatar or a conversation content between the avatars.

6. The advertisement management system according to claim 5, wherein
the at least one processor is further configured to execute the instructions to:
control the timing related to the output of the advertisement based on a reaction of the user participating in the virtual space by operating each of the plurality of avatars with respect to the output advertisement.

7. The advertisement management system according to claim 5, wherein
the at least one processor is further configured to execute the instructions to:
control the timing related to the output of the advertisement based on directions of lines of sight, faces, or heads of the plurality of avatars.

8. The advertisement management system according to claim 1, wherein
the at least one processor is further configured to execute the instructions to:
select an advertisement for each of a plurality of groups of avatars associated with each other in the virtual space.

9. An advertisement management method comprising:
detecting avatars associated with each other in a virtual space to which an advertisement is to be output;
analyzing at least one of an action common to the detected avatars and a conversation content between the avatars;
selecting an advertisement for a plurality of users participating in the virtual space by operating each avatar based on an analysis result; and
outputting an advertisement to be displayed in the virtual space based on a result of the selection.

10. The advertisement management method according to claim 9, further comprising:
selecting the advertisement further based on at least one of an attribute of a user participating in the virtual space and an attribute of the virtual space.

11. The advertisement management method according to claim 9, further comprising:
analyzing a target in which a plurality of users participating in the virtual space by operating the avatar are interested in common based on an action of the avatar or a conversation content between the avatars.

12. The advertisement management method according to claim 9, further comprising:
excluding use a use history not desired to be used by the user from selection of the advertisement when the advertisement is selected using the use history of the user who participates in the virtual space by operating the avatar.

13. The advertisement management method according to claim 9, further comprising:
controlling a timing related to output of the advertisement based on an action of the avatar or a conversation content between the avatars.

14. The advertisement management method according to claim 13, further comprising:
controlling the timing related to the output of the advertisement based on a reaction of the user participating in the virtual space by operating each of the plurality of avatars with respect to the output advertisement.

15. The advertisement management method according to claim 13, further comprising:
controlling the timing related to the output of the advertisement based on directions of lines of sight, faces, or heads of the plurality of avatars.

16. The advertisement management method according to claim 9, further comprising:
selecting an advertisement for each of a plurality of groups of avatars associated with each other in the virtual space.

17. A non-transitory recording medium recording an advertisement management program that cause a computer to execute:
detecting avatars associated with each other in a virtual space to which an advertisement is output;
analyzing at least one of an action common to the detected avatars and a conversation content between the avatars;
selecting an advertisement for a plurality of users participating in the virtual space by operating each avatar based on an analysis result; and
outputting an advertisement to be displayed in the virtual space based on a result of the selection.

18. The non-transitory recording medium recording the advertisement management program according to claim 17, wherein
the advertisement management program further causes the computer to execute:
selecting the advertisement further based on at least one of an attribute of a user participating in the virtual space and an attribute of the virtual space.

19. The non-transitory recording medium recording the advertisement management program according to claim 17, wherein
the advertisement management program further causes the computer to execute:
analyzing a target in which a plurality of users participating in the virtual space by operating the avatar are interested in common based on an action of the avatar or a conversation content between the avatars.

20. The non-transitory recording medium recording the advertisement management program according to claim 17, wherein
the advertisement management program further causes the computer to execute:
excluding use a use history not desired to be used by the user from selection of the advertisement when the advertisement is selected using the use history of the user who participates in the virtual space by operating the avatar.
